(19) United States
(12) Patent Application Publication
(10) Pub. No.: US 2009/0031242 A1
(43) Pub. Date: Jan. 29, 2009

(54) METHODS AND APPARATUS FOR PRESENTING A TARGETED PRESENTATION

(76) Inventor: Seth Zeitlin, Merrick, NY (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/782,468

(22) Filed: Jul. 24, 2007

(51) Int. Cl. G06F 3/048

(52) U.S. Cl. 715/780

(57) ABSTRACT

Method and apparatus for presenting a recipient a recipient with a targeted presentation are described. An example method involves including a code in a first medium, including a first presentation in the first medium, and directing the recipient to a second medium related to the first presentation. At the second medium, the method requests the recipient to enter additional recipient information. The example method also involves storing the recipient information in a database, presenting the recipient with a second presentation about the first presentation, and including a third presentation based on the recipient information in a third medium

### FIELD OF THE DISCLOSURE

This disclosure relates generally to presentations and, more particularly, to methods and apparatus for presenting targeted presentations.

### BACKGROUND

Presentations such as advertisements are ubiquitous in seemingly every aspect of modern life. Information about the recipients of a presentation is important to the business or organization offering the presentation. The medium in which presentations are included can be sources of information about the recipient. For example, a subscriber profile database of a magazine may hold recipients' names and addresses, as well as other useful information that may be helpful in marketing and market research. Businesses typically want to put presentations in specific media to maximize the exposure of the presentations to particular recipients. Knowledge of the media and potential recipients is utilized in the placement of the presentations. For example, a business that sells hair products would most likely advertise its products in fashion magazines where the hair products are more likely to draw interest from the readers.

Conventionally, presentations are unilaterally exhibited to individuals or groups of individuals who allegedly match a desired demographic. Any subsequent presentations to these individuals is independent from the previous presentation(s) and/or any action or non-action taken by the individuals. Thus, the subsequent presentations do not advance a dialog with or better understanding of the recipients and, consequently, may be ineffective.

### BRIEF DESCRIPTION OF THE DRAWINGS

FIG. 1 is a flow chart of an example process for presenting a targeted presentation.

FIG. 2 is an illustration of an example first medium with an example code.

FIG. 3 is an illustration of an example first presentation included in the first medium.

FIG. 4 is an illustration of an example first display of an example second medium requesting the example code.

FIG. 5 is an illustration of an example second display of the example second medium requesting additional information.

FIG. 6 is an illustration of an example third display of the example second medium with an example second presentation about the first presentation.

FIG. 7 is an illustration of an example third medium with an example and targeted third presentation.

FIG. 8 is an illustration of an alternative example second medium requesting the example code.

FIG. 9 is an illustration of yet another alternative example second medium with an example first display requesting the example code.

FIG. 10 is an illustration of an example second display of the example second medium of FIG. 9 requesting additional recipient information.

FIG. 11 is an illustration of an example third display of the example second medium of FIG. 9 with an example second presentation.

FIG. 12 is a block diagram of an example system that may be used to present a targeted presentation.

FIG. 13 is a block diagram of an example processor system that may be used to implement the example methods and systems described herein.

### DETAILED DESCRIPTION

Although the following describes example methods, apparatus or systems including, among other components, software and/or firmware executed on hardware, it should be noted that such methods and apparatus are merely illustrative and should not be considered as limiting. For example, it is contemplated that any or all of these hardware, software, and firmware components could be embodied exclusively in hardware, exclusively in software, or in any combination of hardware and software. Accordingly, while the following describes example methods and apparatus, persons of ordinary skill in the art will readily appreciate that these examples provided are not the only way to implement such methods and apparatus.

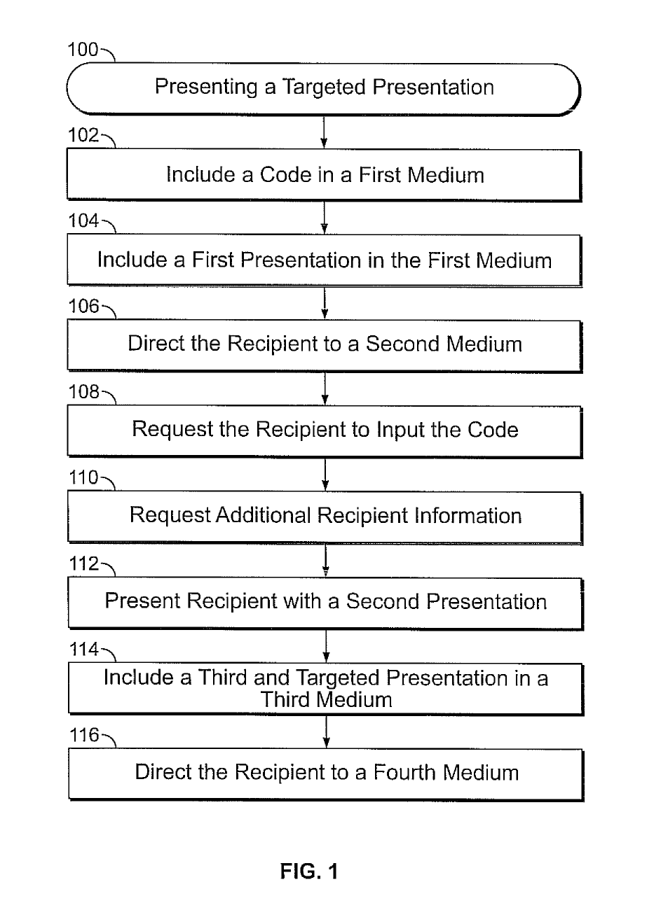

Further, although the example systems or processes are described with reference to the flow chart illustrated in FIG. 1, persons of ordinary skill in the art will readily appreciate that many other methods of presenting a targeted presentation may alternatively be used. For example, the order of execution of the blocks may be changed, and/or some of the blocks described may be changed, eliminated or combined.

FIG. 1 is a flow chart of an example process 100 for presenting a targeted presentation. In the example process 100, blocks 102, 104 and 106 occur at or in a first or primary medium. The first medium may be, for example, a magazine, a mailer, a periodical, a circular, a website, a broadcast, a web-cast, a message on a computer, mobile phone or personal digital assistant, etc., or any combination thereof. In the first medium, a code is included (block 102). The code may be any of any length and of alphanumeric characters or any other characters. Also, in the first medium, a first or primary presentation is included (block 104). The presentation may be one or more of an advertisement, an announcement, a commercial, an infomercial, a game, a lottery, a sweepstakes, etc., or any combination thereof. Further, in accordance with the example process 100, a recipient of the first medium is directed to a second or secondary medium for more information about the first presentation (block 106). The second medium may be, for example, a magazine, a mailer, a periodical, a circular, a website, a broadcast, a web-cast, a message on a computer, mobile phone or personal digital assistant, etc., or any combination thereof.

In the example process 100, blocks 108, 110 and 112 occur at or in the second medium to which the recipient was directed (block 106). At or in the second medium, the recipient is requested to input the code (block 108). Once the recipient has entered the code, it may be determined whether a profile of the recipient is in a database. If the recipient's profile is in the database, the recipient may be presented with a personalized and/or edited content based on information in the profile. If the recipient profile is not found in the database, the recipient may be requested for recipient information that may be stored in the database. In the example targeted presentation process 100, the recipient is also requested for additional recipient information (block 110) that also may be stored in the database. In addition, at or in the second medium, the recipient is presented with a second or secondary presentation related to the first presentation (block 112).

Based on the recipient information, a third and targeted presentation is included at or in a third medium (block 114). The third medium also may be, for example, a magazine, a mailer, a periodical, a circular, a website, a broadcast, a web-cast, a message on a computer, mobile phone or personal digital assistant., etc., or any combination thereof. Further, in accordance with the example process 100, a presentation (e.g., the third presentation) in the third medium may direct the recipient to a fourth medium that is related to the third presentation (block 116). At or in the fourth medium, the recipient may be requested to enter the code and/or requested for yet additional recipient information and so forth. The example process 100 may continue in a similar manner as described and continue forward to subsequent presentations in subsequent mediums and may continue potentially indefinitely.

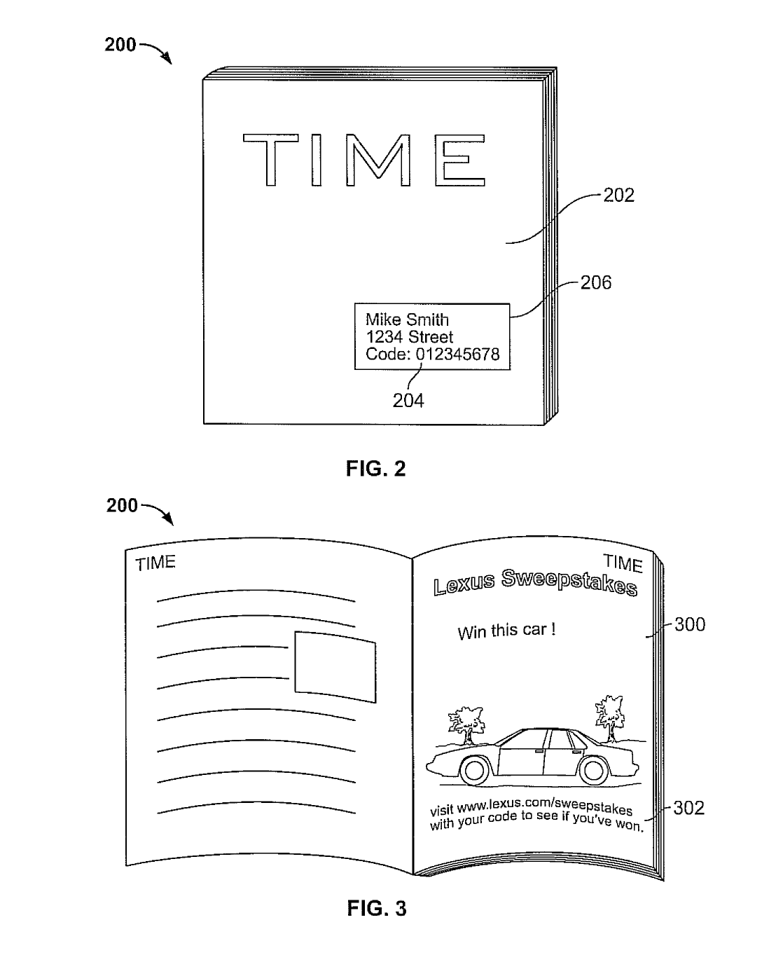

FIGS. 2 and 3 depict an example first medium 200 (e.g., the first medium described above in relation to blocks 102 to 106 of the example targeted presentation process 100 of FIG. 1). The example first medium 200 shown in FIG. 2 is a magazine, though any of the above-noted media may be used as well. FIG. 2 depicts the example first medium 200 including an example code 204. The example code 204 may be a personal identifying code unique to the recipient that may be used to retrieve, edit, and/or add to the recipient information in a database. While FIG. 2 depicts the code 204 as a ten-digit number, the code 204 may include any alpha-numeric characters or other characters of any length and combination such as, for example, a personalized reference, a personal identification number (PIN), a nickname, a username, an email address of the recipient, or a completely arbitrary designation, etc. Furthermore, in the illustrated example first medium 200, the code 204 is included on a magazine cover page 202 of the first medium 200 and displayed inside an address field 206 below the name and the address of the recipient. While FIG. 2 depicts the code 204 as being displayed on the cover 202 of the first medium 200, the code 204 may appear anywhere at or in the first medium 200 such as, for example, inside portion of the cover 202, on any or multiple pages of the first medium 200, standing alone, printed on an insert piece, etc.

FIG. 3 depicts an example first presentation 300 (e.g., the first presentation described in block 104 of the example targeted presentation process 100 of FIG. 1) in the first medium 200. The example first presentation 300 shown in FIG. 3 is a sweepstakes to win a new car. While FIG. 3 depicts the example first presentation 300 as a sweepstakes, the first presentation 300 may be any kind of presentation such as, for example, advertisement, commercial, infomercial, games, lotteries, etc., or any combination thereof. The example presentation 300 of FIG. 3 also includes an example direction 302 to a second medium (e.g., the directing the recipient to the second medium described in block 106 of the example targeted presentation process 100 of FIG. 1). The example direction 302 shown in FIG. 3 indicates that the recipient should go to a website address for further information about the first presentation 300 (i.e., the example direction 302 shown in FIG. 3 prompts the recipient to visit the website to see if the recipient has won the sweepstakes presented in the example first presentation 300). While FIG. 3 depicts the example direction 302 as an inclusion of a website address, the direction 302 may be any type of instruction to reach any other media such as, for example, address, phone number, page number, etc., or any combination thereof.

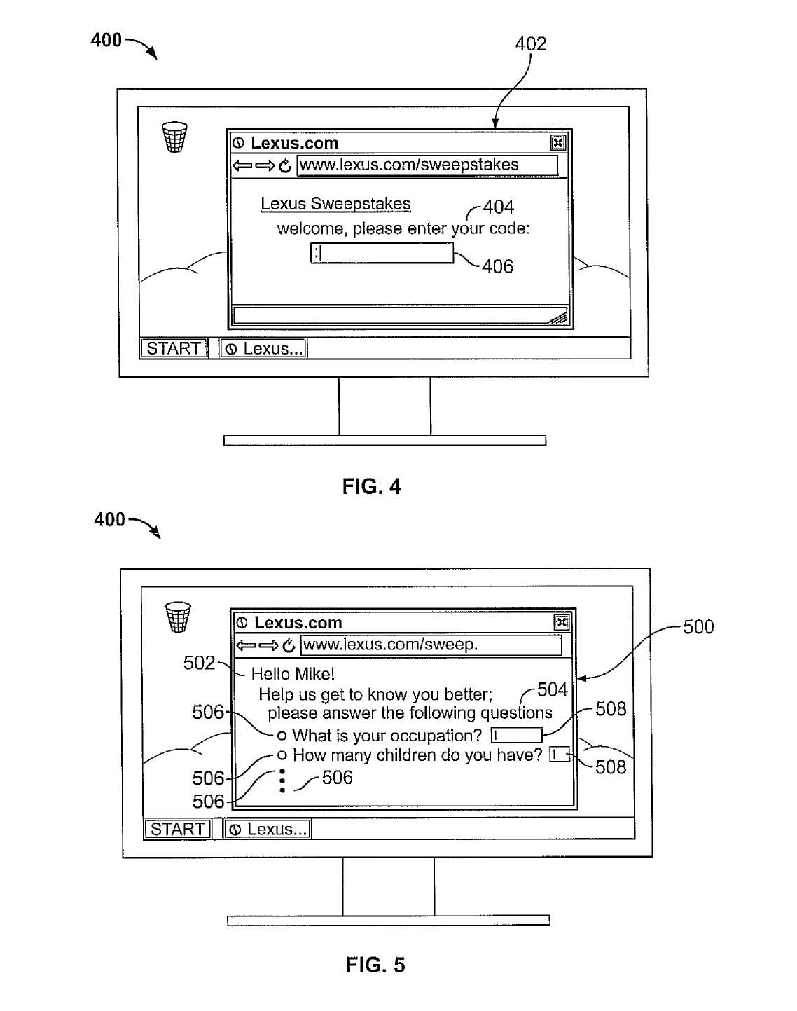

FIGS. 4, 5 and 6 depict example displays of an example second medium 400 (e.g., the example second medium described above in relation to blocks 108, 110 and 112 of the example targeted presentation process 100 of FIG. 1). The example second medium 400 shown in FIGS. 4, 5, and 6 is several of pages from a website. While FIGS. 4, 5 and 6 depicts the second medium as a website, the second medium 400 may be any form of communication as described above such as, for example, a periodical, a circular, a website, a broadcast, a web-cast, etc., or any combination thereof.

FIG. 4 depicts an example first display 402 of the example second medium 400 related to the direction 304 of the first presentation 302 of FIG. 3. The first example display 402 shown in FIG. 4 is a website page that includes a request 404 to input the code 204 (e.g., the request to input the code described in block 108 of the example targeted presentation process 100 of FIG. 1). As shown in FIG. 4, the request 404 prompts the recipient to enter the code 204 by, for example, the text: “Welcome, please enter your code . . . ” The request 404 is followed by a code field 406 where the recipient may input the code 204. While FIG. 4 depicts the request 404 as a specific statement with the corresponding code field 406, any type of message or data gathering technique may be used to request or gather the code 204 from the recipient.

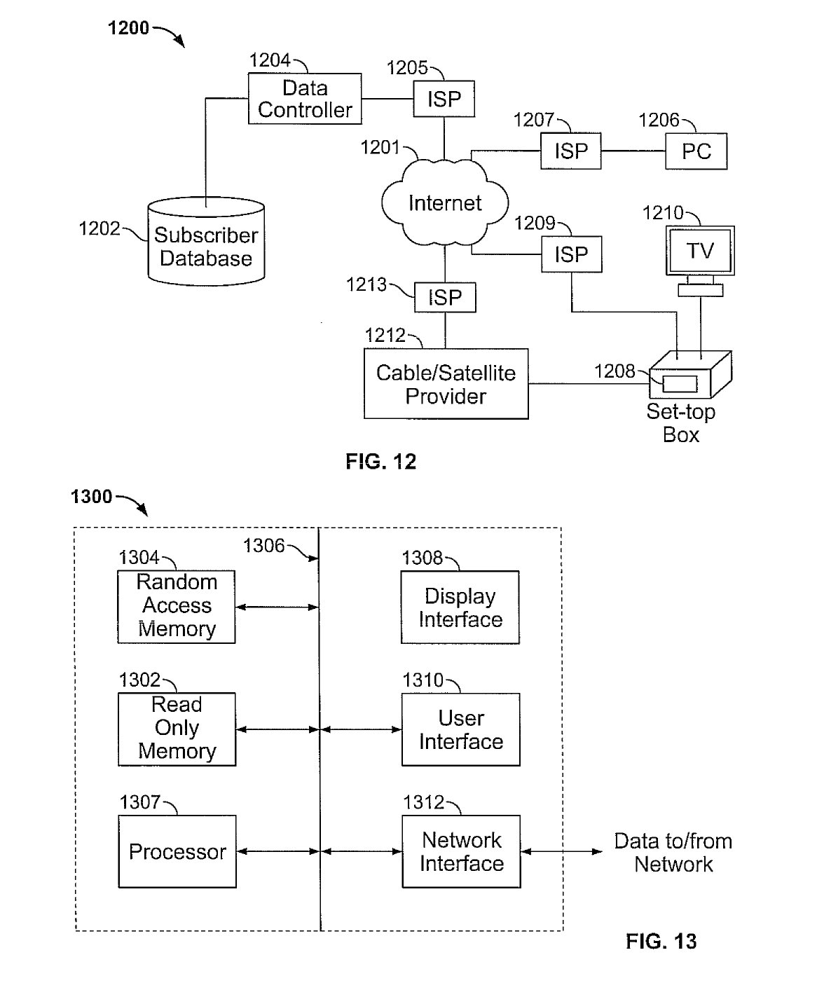

Once the recipient has entered the code 204, it may be determined whether the recipient's profile is in a database (see FIG. 12 discussed below). Searching and determining the presence of the recipient's profile in the database may be implemented in various ways such as, for example, through the internet, telephone lines, satellites, etc. If the recipient's profile is in the database, the information may be retrieved and used to present the recipient with a personalized and/or edited content based on the information in the profile, which is described in greater detail below in FIG. 5. If the recipient profile is not found in the database, the recipient may be requested for recipient information that may be stored in the database.

FIG. 5 depicts an example second display 500 of the example second medium 400. The example second display 500 shown in FIG. 5 is a website page that includes a personalized greeting 502. As shown in FIG. 5, the personalized greeting 502 welcomes the recipient with, for example, the text: “Hello Mike!” The example second display 500 also includes a request for additional recipient information 504 (e.g., the request for more recipient information described in block 110 of the example targeted presentation process 100 of FIG. 1). The request for more recipient information 504 may be, for example, text that prompts the recipient for additional information such as: “Help us get to know you better. Please answer the following questions . . . .” The request for recipient information 504 is followed by one or more recipient information questions 506. Also, as shown in FIG. 5, each of the recipient information questions 506 may be followed by corresponding recipient information fields 508 where the recipient may give his/her answers. While FIG. 5 depicts the request for recipient information 504 as a specific statement and series of recipient information questions 506 and corresponding recipient information fields 508, any type of message or data gathering technique may be used to request or gather additional information from the recipient.

When additional recipient information is gathered, the information may be stored in a database (see FIG. 12 discussed below). Transferring the gathered recipient information may be implemented in various ways such as, for example, through the internet, telephone lines, satellites, etc. Also, the storing of the gathered recipient information in the database may be in a memory such as, for example, a read only memory (ROM), random access memory (RAM), any other type of memory, or any combination thereof. The storing of the recipient information is further explained in FIG. 12 below.

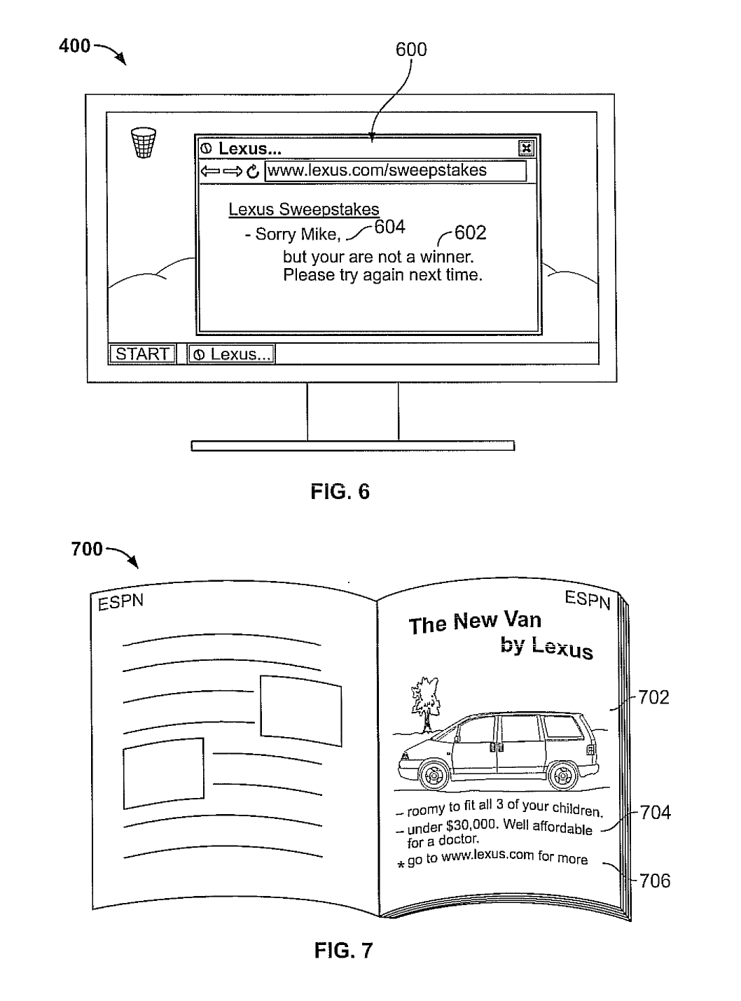

FIG. 6 depicts an example third display 600 of the example second medium 400 with an example second presentation 602 about the example first presentation 302 (e.g., the presentation of information about the first presentation described in block 112 of the example targeted presentation process 100 of FIG. 1). The example third display 600 shown in FIG. 6 is a website page that displays the second presentation 602 and provides the recipient with information regarding the first presentation 302 in the first medium 200. As shown in FIG. 6, the second presentation 602 informs the recipient that the recipient has not won the sweepstakes by, for example, providing the text: “Sorry Mike, but you are not the winner. Please try again next time”. Also, the second presentation 602 may include personalized content 604 such as, for example, the recipient's name in the second presentation 602. While FIG. 6 depicts the example third display 600 and its contents as personalized text statements, information about the first presentation 302 may be presented to the recipient in any other way such as, for example, through one or more of photos, illustrations, audios, videos, etc. Also, other information from the subscriber profile database may be used to further modify the second presentation 602 such as, for example, providing a weather report for the area surrounding the recipient's home address, presenting a targeted advertisement about the recipient's favorite sports team, etc.

FIG. 7 illustrates an example third medium 700. The example third medium 700 shown in FIG. 7 is a magazine. While FIG. 7 depicts the example third medium 700 as a magazine, in other examples, the third medium may be any form of the above-noted media including, for example, a subsequent magazine publication or email sent to the recipient, etc. Also, the third medium 700 shown in FIG. 7 includes an example third and targeted presentation 702 based on the recipient information gathered in the database (e.g., the third presentation in the third medium described in block 114 of the example targeted presentation process 100 of FIG. 1). The example third presentation 702 shown in FIG. 7 is an advertisement for a new car. While FIG. 7 depicts the example third presentation 702 as an advertisement, the third presentation 702 may be any kind of presentation such as, for example, advertisement, commercial, infomercial, games, lotteries, etc. or any combination thereof that may be stylized, directed, personalized or otherwise constructed and/or targeted to the recipient based on the recipient's profile and/or history with responding or not responding to previous presentations. For example, in FIG. 7, the example third and targeted presentation 702 incorporates the recipient's profile information in advertising the car via the text: “roomy to fit all 3 of your children,” and “under $30,000. Well affordable for a doctor”. While FIG. 7 depicts the example third and targeted presentation 702 as including the personalized statement, the third and targeted presentation 702 may incorporate any information gathered in the recipient profile such as, for example, photos of the recipient.

Also, the example third presentation 702 shown in FIG. 7 may includes a direction 706 to a fourth medium (e.g., the directing the recipient to the fourth medium described in block 116 of the example targeted presentation process 100 of FIG. 1). The example direction 706 shown in FIG. 7 includes a website address. For example, in FIG. 7, the example direction 706 shown in FIG. 7 prompts the recipient of the example third medium 700 to visit a website to find more information about the advertised car. While FIG. 7 depicts the example direction 706 as an inclusion of a website address, the example direction 706 may be any type of instruction to reach any other media such as, for example, including or providing an address, a phone number, a page number, etc., or any combination thereof.

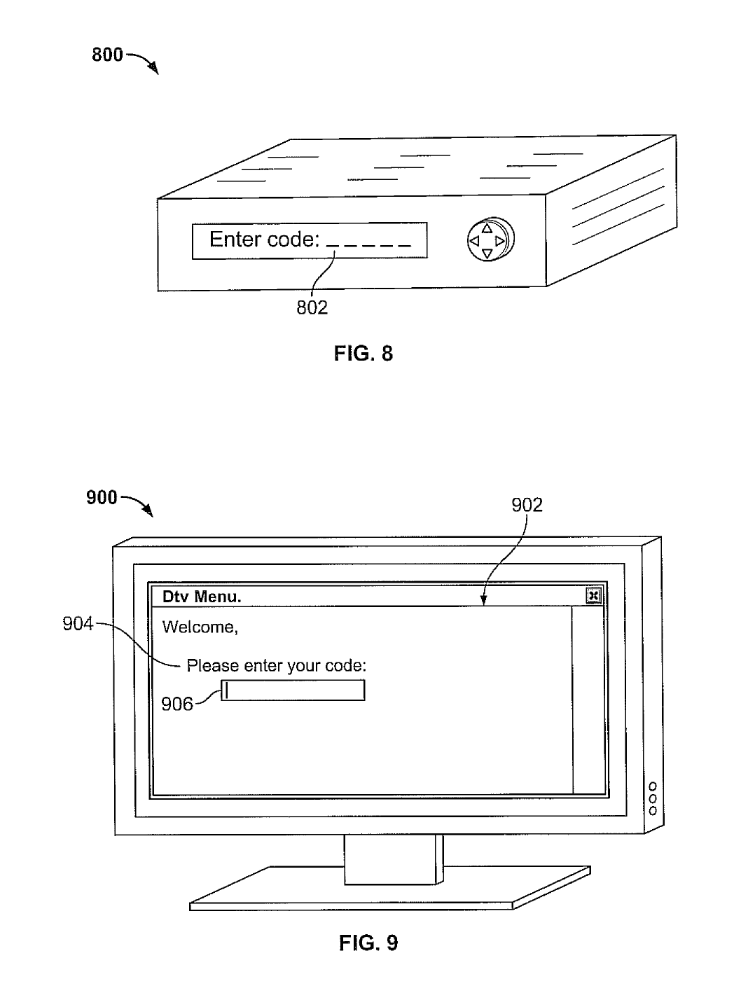

FIG. 8 depicts an alternative example second medium 800. The example second medium 800 shown in FIG. 8 is a set-top box that includes a code input field 802 where the recipient may enter the code 204 (e.g., the requesting to input the code described in block 108 of the example targeted presentation process 100 of FIG. 1). The example second medium 800 may be associated with various television satellite/cable program providers such as, for example, DirecTV, Dish Network, Comcast, etc. Also, the code 204 may be inputted to a code input field 802 using various data entry methods such as, for example, using a remote control, using the key-pad on the set-top box, etc.

FIG. 9 depicts another alternative example second medium 900. The example second medium 900 shown in FIG. 9 is a television monitor that includes an example first display 902. The example first display 902 as shown in FIG. 9 is an interactive menu screen that includes a request 904 to enter the code 204 (e.g., the requesting to input the code described in block 108 of the example targeted presentation process 100 of FIG. 1). For example, in FIG. 9, the request 904 prompts the recipient to enter the code 204 with, for example, the text: “Welcome, please enter your code . . . ” The request 904 may be followed by a code field 906 where the recipient may input the code 204. While FIG. 9 depicts the request 904 as a specific statement with the corresponding code field 906, any type of message or data gathering technique may be used to request or gather the code 204 from the recipient.

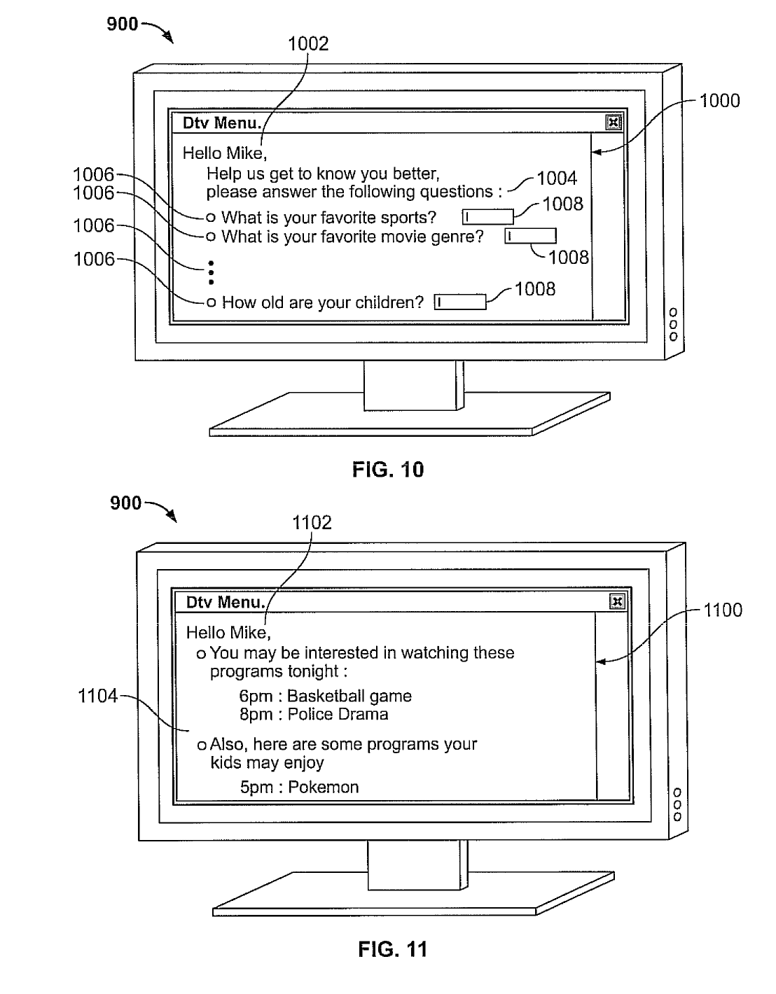

FIG. 10 depicts an example second display 1000 of the example second medium 900. The example second display 1000 shown in FIG. 10 is an interactive menu screen that includes a personalized greeting 1002. For example, in FIG. 10, the personalized greeting 1002 welcomes the recipient with, for example, the text: “Hello Mike!” in text form. Also in FIG. 10, the example second display 1000 includes a request for more recipient information 1004 (e.g., the request for more recipient information described in block 110 of the example targeted presentation process 100 of FIG. 1). The request for additional recipient information 1004 may be, for example, text that prompts the recipient for additional information such as: “help us get to know you better. Please answer the following questions . . . ” The request for recipient information 1004 may be followed by one or more recipient information questions 1006 and one or more recipient information fields 1008 where the recipient may give his/her answers. While FIG. 10 depicts the request for recipient information 1004 as a specific statement and series of recipient information questions 1006 and corresponding recipient information fields 1008, any type of messages or data gathering techniques may be used to request or gather additional information from the recipient.

FIG. 11 depicts an example third display 1100 of the second medium 900 where the recipient information may be utilized after the recipient has entered the code 204 (e.g., presenting recipient with second presentation about the first presentation described in block 112 of the example targeted presentation process 100 of FIG. 1). The example third display 1100 shown in FIG. 11 is a menu screen where the recipient is welcomed with a personalized greeting 1102. For example, in FIG. 11, the personalized greeting 1102 acknowledges the recipient with a personalized message, e.g., “Hello Mike . . . ” Also in FIG. 11, the example third display 1100 includes an example second presentation 1104. The example second presentation 1104 shown in FIG. 11 may be a targeted presentation such as, for example, presenting a list of currently available programs in which the recipient may be interested. For example, the example second presentation 1104 of FIG. 11 informs the recipient that there are two television programs the recipient may be interested in watching: a basketball game at 6 pm and a drama at 8 pm. While the example second presentation 1104 of FIG. 11 is personalized television scheduling information, the second presentation 1104 may be any kind of presentation such as, for example, advertisement, commercial, infomercial, games, lotteries, etc. or any combination thereof. Also, while FIG. 11 depicts the example third display 1110 and its contents as personalized text statements, the second presentation 1104 may be presented to the recipient in any other way such as, for example, through photos, illustrations, audios, videos, etc., or any combination thereof. Furthermore, the example targeted presentation process of FIG. 1 may be used to display other personalized and/or modified greetings and/or display targeted advertisements that may be of the recipient's interest. For example, the second presentation 1104 of FIG. 11 also provides the recipient with currently available programs that may be of interest to the recipient's children.

FIG. 12 depicts an example system for presenting targeted presentations 1200 that may be used to implement the example targeted presentation 1200 that may be used to implement the example targeted presentation process 100 of FIG. 1. FIG. 12 depicts a subscriber profile database 1202 that stores the subscriber profiles of the recipients. Subscriber profile database 1202 may include any desired type of mass storage device(s) including hard disk drives, optical drives, tape storage devices, etc. Subscriber profile database 1202 is coupled with a data controller unit 1204 which may handle, oversee and/or control requests for and/or use of the information in the subscriber profile database 1202. While FIG. 12 depicts the data controller 1204 as a single hardware unit that is coupled to the subscriber profile database 1202, the data controller 1204 may be implemented using various systems and apparatuses such as, for example, multiple computers distributed over the Internet, etc. The subscriber profile database 1202 and the data controller 1204 are coupled to the Internet 1201 via an internet service provider (ISP) 1205. FIG. 12 also depicts an example PC 1206 which may be used to access a medium such as, for example, the example medium 400 (as shown in FIGS. 4-6). The PC 1206, which is coupled to the Internet 1201 via a second ISP 1207, may be in communication with the subscriber profile database 1202 and the data controller 1204 via the first ISP 1205 and the Internet 1201. Any medium for accessing the Internet may be used in place of the PC 120-6 such as, for example, laptop, personal digital assistants (PDAs), cell phones, etc.

The example system 1200 as shown in FIG. 12 also may or alternatively include a set-top box 1208 to, for example, implement the example targeted presentation process 100 of FIG. 1 via the example medium of FIGS. 8-11. The set-top box 1208 is coupled to a cable/satellite provider 1212 that provides the set-top box with the contents to be displayed. The connection between set-top box 1208 and cable/satellite provider 1212 may be any methods of multimedia communication such as, for example, satellite, cable, internet, etc. Also, the cable/satellite provider 1212 may be coupled to the Internet 1201 via a third ISP 1213. The set-top box 1208 also is coupled to a display 1210 where the contents received by the set-top box 1208 may be displayed. The set-top box 1208 is coupled to the Internet 1201 via a fourth IPS 1209. The set-top box 1208 may be in communication with the subscriber profile database 1202 and the data controller 1204 via either the Internet 1201 or the cable/satellite provider 1212. Therefore, the set-top box 1208 may be configured to receive a targeted presentation (e.g., the targeted presentation 1104 of FIG. 11) from the cable/satellite provider 1212 or personalize and/or edit the received content at the set-top box 1208.

FIG. 13 is a block diagram of an example processor system 1300 that may be used to implement the systems and methods described herein. The example processor system 1300 of FIG. 13 is in communication with a main memory (including a read-only memory (ROM) 1302 and a random-access memory (RAM) 1304) via a bus 1306. As shown in FIG. 13, the processor system 1300 includes a processor 1307 that is coupled to the bus 1306. The processor 1307 may be any suitable processor, processing unit or microprocessor. Although not shown in FIG. 13, the processor system 1300 may be a multi-processor system and, thus, may include one or more additional processors that are identical or similar to the processor 1307 and that are communicatively coupled to the interconnection bus 1306.

The example RAM 1304 of FIG. 13 may be implemented by dynamic random access memory (DRAM), Synchronous DRAM (SDRAM), and/or any other type of RAM device, and the example ROM 1302 of FIG. 13 may be implemented by flash memory and/or any other desired type of memory device including mass storage devices such as, for example, hard disk drives, optical drives, tape storage devices, etc. Access to the example memories 1302 and 1304 is typically controlled by a memory controller (not shown) in a conventional manner.

The example processor system 1300 also includes a display interface 1308 to communicate with various display peripherals (e.g., computer monitors used to display the example second presentation 602 of FIG. 6 or television 900 of FIG. 9). The display interface 1308 may be used to communicate generated outputs (e.g., the example first display 402 of FIG. 4 and the example second display 500 of FIG. 5).

In addition, to allow a user to input data, the example processor system 1300 includes any variety of user interface 1310. Example user interface 1310 may include a keypad, mouse, microphone, etc.

To allow the example processor system 1300 to interact with a remote server, the example processor system 1300 of FIG. 13 includes any variety of network interface 1312 such as, for example, a wireless LAN interface in accordance with, for instance, the Institute of Electronics and Electrical Engineers (IEEE) 802.11b, 802.11g, 802.15.4 (a.k.a. ZigBee), etc. standards. The example processor system 1300 of FIG. 13 may use the example network interface 1312 to obtain/store recipient profile information from/to the database.

Although the example processor system 1300 has been illustrated in FIG. 13, the example processor system 1300 may be implemented using any of a variety of other and/or additional devices, components, circuits, modules, etc. Further, the devices, components, circuits, modules, elements, etc. illustrated in FIG. 13 may be combined, re-arranged, eliminated and/or implemented in any of a variety of ways. For simplicity and ease of understanding, the following discussing references the example processor system 1300, but any processor system could be used instead.

Although certain example apparatus, methods, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of presenting a recipient with a targeted presentation, the method comprising:
including a code in a first medium;
including a first presentation in the first medium;
directing the recipient to a second medium related to the first presentation;
requesting the recipient to enter the code at the second medium;
requesting recipient information from the recipient through the second medium;
storing the recipient information in a database;
presenting the recipient with a second presentation about the first presentation through the second medium; and
including a third presentation in a third medium based on the recipient information.

2. A method of presenting a recipient with a targeted presentation as defined in claim 1 further comprising including the code in the third medium.

3. A method of presenting a recipient with a targeted presentation as defined in claim 1, wherein each of the first medium, the second medium, and the third medium is at least one of a periodical, a mailer, a circular, a website, a broadcast, a webcast, or a message on a computer, mobile phone or personal digital assistant.

4. A method of presenting a recipient with a targeted presentation as defined in claim 1, wherein each of the first presentation, the second presentation, and the third presentation is at least one of an advertisement, an announcement, a commercial, an infomercial, a game, a lottery, or a sweepstakes.

5. A method of presenting a recipient with a targeted presentation as defined in claim 1, wherein the first medium and the third medium are different.

6. A method of presenting a recipient with a targeted presentation as defined in claim 1 further comprising including the code in a satellite receiver or a set-top box.

7. An apparatus for presenting a recipient with a targeted presentation, the apparatus comprising:
a memory; and
a processor coupled to the memory, wherein the processor is programmed to:
receive a code associated with a first presentation and a first medium, wherein the code is to be received in a second medium;
request recipient information from a recipient of the first medium, wherein the recipient information is to be received at the second medium;
store the recipient information in the memory;
present the recipient with information about the first presentation; and
include a targeted presentation in a third medium based on the recipient information.

8. An apparatus for presenting a recipient with a targeted presentation as defined in claim 7, wherein the processor is further programmed to include the code in the third medium.

9. An apparatus for presenting a recipient with a targeted presentation as defined in claim 7, wherein each of the first medium and the third medium is at least one of a periodical, a mailer, a circular, a website, a broadcast, a webcast, or a message on a computer, mobile phone or personal digital assistant.

10. An apparatus for presenting a recipient with a targeted presentation as defined in claim 7, wherein each of the first presentation and the targeted presentation is at least one of an advertisement, an announcement, a commercial, an infomercial, a game, a lottery, or a sweepstakes.

11. An apparatus for presenting a recipient with a targeted presentation as defined in claim 7, wherein the first medium and the third medium are different.

12. An apparatus for presenting a recipient with a targeted presentation as defined in claim 7, wherein the code is associated with a satellite receiver or a set-top box.

13. A medium including a targeted presentation formed by:
including a code in a preliminary medium;
including a preliminary presentation in the preliminary medium;
directing the recipient of the preliminary medium to a secondary medium related to the preliminary presentation;
requesting the recipient to enter the code at the secondary medium;
requesting recipient information from the recipient through the secondary medium;
storing the recipient information in a database;
presenting the recipient with a secondary presentation about the preliminary presentation through the secondary medium; and
including the targeted presentation in the medium based on the recipient information.

14. A medium including a targeted presentation as defined in claim 13, wherein the medium is formed by also including the code in the medium.

15. A medium including a targeted presentation as defined in claim 13, wherein the preliminary medium and the secondary medium and the medium are at least one of a periodical, a mailer, a circular, a website, a broadcast, a webcast, or a message on a computer, mobile phone or personal digital assistant.

16. A medium including a targeted presentation as defined in claim 13, wherein the preliminary presentation, the secondary presentation and the targeted presentation are at least one of an advertisement, an announcement, a commercial, an infomercial, a game, a lottery, or a sweepstakes.

17. A medium including a targeted presentation as defined in claim 13, wherein the preliminary medium and the secondary medium and the medium are different.

18. A medium including a targeted presentation as defined in claim 13, wherein the medium is formed by also including the code in a satellite receiver or a set-top box.

19. An apparatus for presenting a recipient with a targeted presentation, the apparatus comprising:
means for including a code in a first medium;
means for including a first presentation in the first medium;
means for directing the recipient to a second medium related to the first presentation;
means for requesting the recipient to enter the code at the second medium;
means for requesting recipient information from the recipient through the second medium;
means for storing the recipient information in a database;
means for presenting the recipient with second presentation about the first presentation through the second medium; and
means including a third presentation in a third medium based on the recipient information.

20. An apparatus for presenting a recipient with a targeted presentation as defined in claim 19 further comprising means for including the code in the third medium.

21. An apparatus for presenting a recipient with a targeted presentation as defined in claim 19, wherein each of the first medium, the second medium and the third medium is at least one of a periodical, a mailer, a circular, a website, a broadcast, a webcast, or a message on a computer, mobile phone or personal digital assistant.

22. An apparatus for presenting a recipient with a targeted presentation as defined in claim 19, wherein each of the first presentation, the second presentation and the third presentation is at least one of an advertisement, an announcement, a commercial, an infomercial, a game, a lottery, or a sweepstakes.

23. An apparatus for presenting a recipient with a targeted presentation as defined in claim 19, wherein the first medium, the second medium and the third medium are different.

24. An apparatus for presenting a recipient with a targeted presentation as defined in claim 19 further comprising means for including the code in a satellite receiver or a set-top box.
